(19) United States
(12) Patent Application Publication
(10) Pub. No.: US 2005/0134682 A1
(43) Pub. Date: Jun. 23, 2005

(54) Network based conference system

(75) Inventors: Mikhail Sandler, Ottawa (CA); Misha Jiline, Ottawa (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: Epiphan Consulting Inc., Ottawa (CA)

(21) Appl. No.: 10/744,219

(22) Filed: Dec. 22, 2003

(51) Int. Cl. H04N 7/14

(52) U.S. Cl. 348/14.08

(57) ABSTRACT

A network based conference system is disclosed for allowing providing image access to remote attendees. The network based conference system includes an image acquisition module which communicates with a collaboration server over a network. Remote attendees may readily monitor an ongoing presentation in near real-time via a network connection to the collaboration server. According to one embodiment of the invention, the remote attendees may monitor the ongoing presentation via the use of a standard Internet browser. The network based conference system is particularly useful for overcoming the requirements of installation and operation of special conferencing software and hardware of network conference systems known in the art.

### FIELD OF THE INVENTION

The present invention relates to a network based conference system and is particularly concerned with providing remote conference participants network access to ongoing presentations in near-real time.

### BACKGROUND OF THE INVENTION

For many years overhead projectors have been popular for providing a display suitable for viewing by a group of meeting attendees. A set of prepared transparencies (also known as a slide deck) are placed upon a projector apparatus and a magnified image is projected upon a viewing screen. Software, such as Microsoft's™ PowerPoint™, simplified preparation of polished presentations.

Subsequent advances in electronics yielded electronic projectors which connect directly to a computer and are electronically driven, for example with a VGA signal, with media content. The displays use the media content to modulate the light and present either a color or black-and-white image on the display screen. The projectors come in different configurations, but typically use a spatial light modulator such as a liquid crystal device to modulate the projected light. Direct connection to a computer video port allows more sophisticated presentations, including animation and video effects. Many portable computers, especially laptop and notebook computers, are provided with a video signal output port. This port is normally used to connect the device to a larger display device than is built in to the portable computer, such as a CRT or flat panel display configured as a docking station.

An obvious shortcoming of such presentation devices is that meeting attendees must be physically present to view the projected display. Remotely located potential participants face a number of problematical choices. These include joining the meeting via telephone conference, thus missing the visual components of the presentation. Alternately, they could travel to the meeting, with the attendant difficulties of travel time and costs, as well as scheduling. Videoconferencing is yet another alternative that has been developed to assist the remote attendee, but has attendant equipment procurement and training costs, as well as requiring costly high bandwidth connections between videoconferencing sites.

The advent of the Internet provided an additional venue for conferencing means. Internet video conferencing software has been developed which allows meeting attendees to experience real-time video conferencing between users running a software application on their personal computers. More sophisticated applications, such as PlaceWare'S™ web based virtual conference system, or Microsoft's™ Exchange Conferencing Server and NetMeeting™ utilize a remote server to host a virtual meeting between attendees.

Limitations with these virtual conferencing applications include the necessity of installation of new software on an attendee's computer, with the attendant security concerns for the IT department of the attendee's organization; and the necessity of the attendee learning how to run the new software. There are also the considerations of operating system compatibility across, for example, Windows™ and Linux platforms, for the new software, and similarly potential hardware limitations across hardware platforms such as Macintosh™, Sun™, HP™ and SGI™. Additionally, the video cameras required to obtain the visual images present their own associated hardware and software interface complexities.

In view of the foregoing, it would be desirable to provide a technique for allowing a remote attendee to view a meeting presentation in real time which overcomes the above-described inadequacies and shortcomings.

### SUMMARY OF THE INVENTION

An object of the present invention is to provide an improved network based conference system.

According to an aspect of the present invention there is provided an apparatus for providing near real time image conferencing from a video signal output from a computer. The apparatus has an input port for connection to the video output of the computer and an image digitizing module, connected to the input port, for receiving a signal from said input port and constructing a digital image therefrom. Further, the apparatus has a controller module, connected to the image digitizing module for generating a compressed representation of a digital image received from the image digitizing module. Finally, the apparatus has a network interface module connected to the controller module, for transmission of the compressed representation to a network device.

Conveniently the controller module is a computer having a driver interface module for communication with the image digitizing module, an image compression module for formatting an image obtained from the image digitizing module and a network process module for providing network protocol functions. The computer also has a network interface driver module for communication with the network interface module.

Various alternatives of the invention have the network interface module alternatively having a modem for transmission over a telephonic network, or having a network interface card for transmission over a digital connection, or an infrared or wireless interface card for transmission over an infrared or wireless connection respectively.

In accordance with another aspect of the present invention there is provided a system for providing near real time image conferencing from a video signal output from a computer across a network. The system has an image acquisition apparatus connected to said network, wherein the image acquisition apparatus has an input port for connection to the video output of the computer; an image digitizing module connected to the input port, for receiving a signal from the input port and constructing a digital image therefrom; a controller module, connected to the image digitizing module, for generating a compressed representation of a digital image received from said image digitizing module; and a network interface module connected to the controller module, for transmission of the compressed representation to the network. The system also has a collaboration server connected to the network for receiving the compressed representation wherein said collaboration server further formats said compressed representation for viewing.

Advantages of the present invention include the lack of a need for custom software at the presenter's computer, or at a remote participant's computer. The video imagery present upon the presenter's computer is automatically made available at the collaboration server. Remote participant's need only access the collaboration server, for example with a web browser if the server is connected to the Internet, to view the conference video proceedings. Joining an ongoing presentation may advantageously be as simple as clicking a hyperlink address. In addition, further advantages may be found in additional functioning supported by the collaboration server including authentication and authorization of meeting participants, maintaining multiple simultaneous meeting image streams, and billing and archival functions.

According to yet another aspect of the invention, there is provided a method for providing near real time image conferencing from a video signal output from a first computer across a network to a second computer. The method has a first step of establishing a video connection between the first computer and an image acquisition apparatus. The image acquisition apparatus has an input port for connection to the video signal output from the first computer; an image digitizing module, connected to the input port, for receiving a signal from the input port and constructing a digital image therefrom; a controller module, connected to the image digitizing module, for generating a compressed representation of a digital image received from the image digitizing module; and a network interface module connected to the controller module, for transmission of the compressed representation to the network. The next step is that of connecting the network interface module of the image acquisition apparatus to the network. Another step is that of establishing a collaboration server connected to the network for acting as an image dissemination point. Then communication is established between the image acquisition apparatus and the collaboration server across the network, thereafter the image acquisition apparatus commences transmitting the compressed representations to the collaboration server. The collaboration server subsequently reformats the received compressed representations. Next, between the second computer establishes a connection to the collaboration server across said network; and the collaboration server provides the reformatted compressed representations to the second computer.

The present invention will now be described in more detail with reference to exemplary embodiments thereof as shown in the appended drawings. While the present invention is described below with reference to the preferred embodiments, it should be understood that the present invention is not limited thereto. Those of ordinary skill in the art having access to the teachings herein will recognize additional implementations, modifications, and embodiments which are within the scope of the present invention as disclosed and claimed herein.

### BRIEF DESCRIPTION OF THE DRAWINGS

The invention will be further understood from the following detailed description of embodiments of the invention and accompanying drawings in which:

FIG. 1 is a pictorial diagram of an electronic projector used in the prior art.

FIG. 2 is a pictorial diagram of a network based conference system according to an embodiment of the invention.

FIG. 3 is a block diagram of an image acquisition module according to an embodiment of the invention.

FIG. 4 is a block diagram of a routine for providing a network based conference according to an embodiment of the invention.

In the following description, like reference numbers refer to similar components.

### DETAILED DESCRIPTION OF THE INVENTION

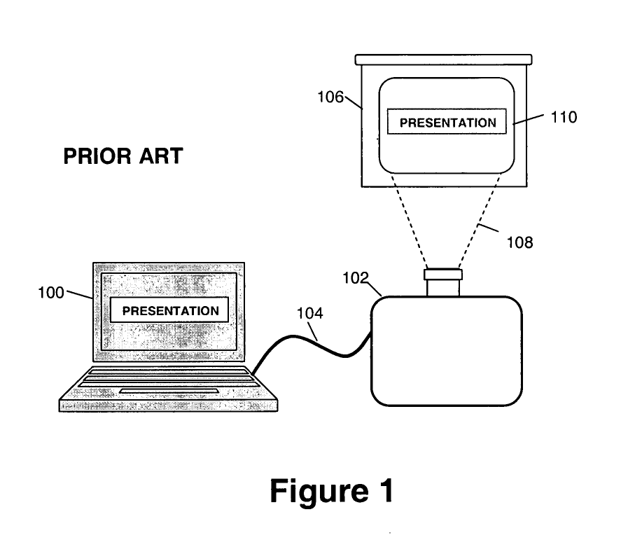

Referring to FIG. 1 there may be seen the presentation projection components of a typical meeting as presently practiced in the art. Computer 100, in this example portrayed as a laptop computer, connects to projector 102 via an interface cable 104. The interface cable 104 connects to a video output port, not shown, of the computer. Video output ports are well known in the art and typically used to connect a laptop computer to a separate display such as a CRT or flat panel display. In the case of the projector 102, the video output is transformed into an optical image for projection, indicated by dashed lines 108, upon presentation screen 106. The net result is that meeting participants may view the contents of the screen of the computer 100, typically a prepared presentation, upon the display screen 106 as indicated at image 110.

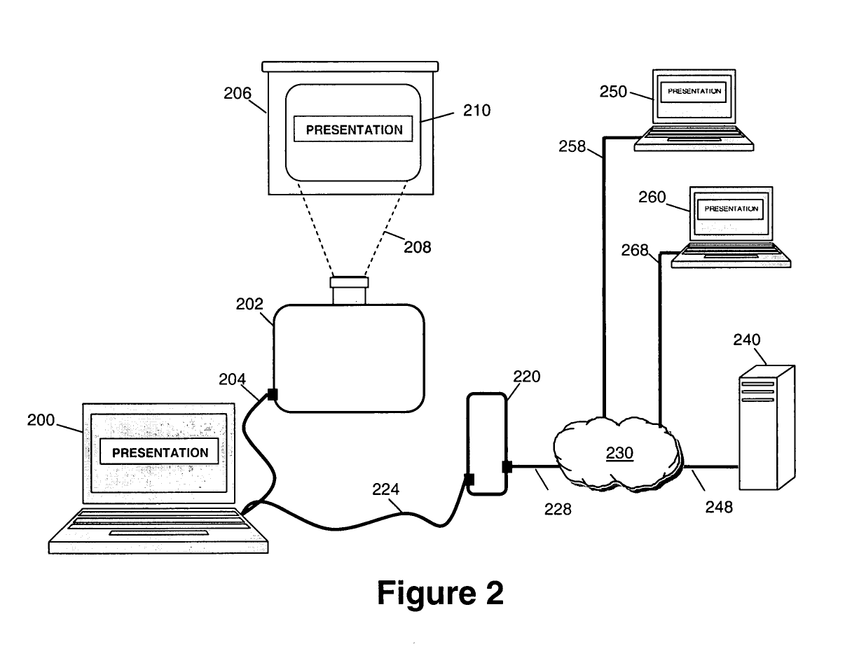

Referring to FIG. 2 there may be seen the presentation projection components of a network based conference system according to an embodiment of the invention. Computer 200 containing a presentation desired to be shared among meeting participants connects to projector 202 via interface cable 204. Projector 202 transforms the video signals received via interface cable 204 into optical images and projects them as indicated at 208 upon presentation screen 206, where the resultant images 210 are visible by the meeting participants. In addition, image acquisition module 220 connects to a video output port of computer 200 via interface cable 224. In practice computer 200 may have two video output ports, or interface cables 204 and 224 could be constructed as a forked cable should computer 200 have but a single video output port. Image acquisition module 220 performs a “snapshot” of the image constituted by the video signals, formats the resultant image, and transmits the resultant formatted image over network 230 to collaboration server 240. Note that image acquisition module 220 is connected to network 230 over network connection 238. This network connection may be as simple as a direct cable, or via other means such as infra-red or wireless connection. Under some circumstances the connection may be to a WI-FI network. The formatting performed by the image acquisition module typically involves image compression and may further involve further processing related to network transmission, for example encapsulation for security purposes. Upon the completion of a snapshot, image acquisition device 220 will perform a subsequent snapshot, format it, and transmit it to collaboration server 240, the net result of which is a succession of images—an image stream, which matches the images presented upon presentation screen 206 in near real-time.

Collaboration server 240 receives the image, reformats it, and makes the image available for viewing. Remote participants 250 and 260, connected to network 230 via network connections 258 and 268 respectively, access the images at collaboration server 240, and are thus able to view the presentation images, thus allowing visual participation in the ongoing presentation. According to one possible use of the system, meeting participants could join a meeting via an audio-bridge via the telephone network, and in parallel view the ongoing presentation on their respective computer screens.

In conjunction with presenting the images, collaboration server 240 may carry out a variety of additional functions related to conference networking. Examples of such functions in relation to participants include authentication of would-be meeting participants, authorization of participants, and billing functions. In relation to image acquisition module 220, collaboration server 240 may perform signalling communication functions in relation to image transmission speed, image compression type used, and ongoing control and adaptation according to network signalling conditions. Other contemplated functions which may be performed at the collaboration server 240, or by the collaboration server 240 and other network devices include meeting scheduling, recording, archival, and playback functions.

According to one embodiment of the invention, collaboration server 240 formats the received succession of images from image acquisition module 220 so that they may be accessed and viewed by standard Internet web browser software. This will typically involve referencing the images from a formatted web page. The remote meeting participants link to the web page via a previously established web address. According to one possibility, the address could be communicated in the meeting invitation or agenda as a hyperlink. Also contemplated during the initial linking to the established meeting web page is a series of security transactions. According to one embodiment, a particular meeting or presentation is distinguished by a particular meeting code, similar to a personal identification number (PIN). In this embodiment, the presenter operating computer 200 and the remote meeting participants can use the meeting code number, either at the initial point of communication with collaboration server 240, or during ongoing communications in order to correctly access the appropriate image stream. This meeting code number could be coordinated among participants prior to the meeting, perhaps using email or some similar notification method.

It is important to note in FIG. 2 that projector 202 and ancillary equipment are not necessary to operation of the network conference system in the case where a presenter wishes to convene a meeting of people solely over a network.

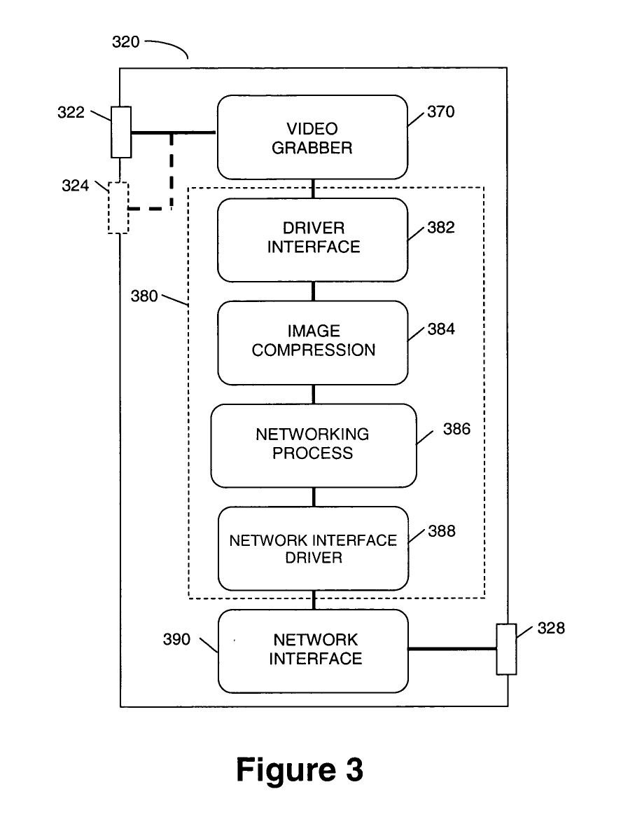

Referring to FIG. 3, there may be seen details of a contemplated embodiment of an image acquisition module 320. Serving as a connection point to image acquisition module 320 is video input connector 322. This is the connection point for the video interface cable which connects to the computer holding the presentation. Contemplated as an option for some embodiments of the invention is ganged video port 324, shown in dashed outline, which provides an advantageous daisy-chaining point for another video interface cable. This connector would be used in a presentation arrangement as shown in FIG. 2 where a connection could be established between the computer 200 of FIG. 2 and the image acquisition module at video input connector 322, and then connected to the projector 202 of FIG. 2 via an interface cable from video connector 324. Such an arrangement precludes the need for special forked cables, or double video output terminals on computer 200.

Returning to FIG. 3, the signal received on video input connector 322 connects to image grabber module 370. This module serves to “grab” the image constituted by the video signal, taking the desired snapshot. This module may have the image grabbing function performed by an off-the-shelf PCI card, or a chain of off-the-shelf devices such as a VGA-to-Video converter and Video-grabber PCI card, or a custom circuit board assembly built from off-the-shelf integrated circuits such as the CYPRESS™ EZ-USB FX USB controller and AD9884A frame grabber. The image grabber module 370 interfaces to the controller module 380. This module is typically composed of a computer system having a CPU, memory, and ancillary support hardware as is known to those skilled in the art. To minimize heat, noise and power consumption, the controller module would typically be implemented using low power consumption circuitry, for example a processing unit based upon the VIA™ system of processor chips.

Within the controller module 380 are a number of functional modules, typically implemented in software. These include driver interface module 382 for retrieving images from image grabber module 370, image compression module 384, which uses standard compression and formatting algorithms such as JPEG or GIF to compress and format the grabbed images, networking process module 386 typically containing a TCP/IP Network stack and HTTP library and associated functions, and network interface driver module 388 which contains the appropriate functions for connection to and control of network interface module 390.

Network interface module 390 provides the connection between the image acquisition module 320 and the network. This module may be a modem for providing connectivity over a telecommunications network, a network interface card for providing connectivity to a local area network, or alternatively an infrared or wireless apparatus. In the case of a physical connection, output connector 328 provides a connection point for an interface cable connecting the network interface module 390 to a network.

The apparatus described could be used in one particular implementation wherein the video signalling used is a VGA signal as follows with reference to FIGS. 2 and 3. The presenter's computer 200 is connected from the VGA output port to image acquisition module 220 using a standard VGA interface cable for interface cable 224. Image data coming over the VGA cable from the presenter's computer 200 is digitized by the frame grabber module 370 and transferred to the main memory of controller module 380 via driver interface module 382. Image compression module 384 periodically retrieves the digitized images from the main memory for compression purposes. In one contemplated embodiment, successive images are compared to see if the image has changed. In this embodiment, only changed images are transmitted to collaboration server 240, thereby saving bandwidth. If an image is available that requires compression, image compression module 384 compresses the image for transmission to the collaboration server 240. Although standard compression algorithms are contemplated, custom algorithms may be implemented by image compression module 384 or elsewhere in controller module 380 should it become advantageous to do so. Via networking process module 386 having control of the TCP/IP stack, and possibly using other HTTP routines, the compressed image is transferred to the collaboration server 240 via network interface module 390 over network 230.

In one possible embodiment, the operating system of controller module 380 is configured to use Dynamic Host Configuration Protocol (DHCP) to automatically and seamless obtain the IP address in the presenter's local area network for use in network transactions between image acquisition module 220 and collaboration server 240.

Continuing with the example wherein network 230 comprises the Internet, collaboration server 240 would have an HTTP server process implemented. Compressed images would be transferred using HTTP protocol. Alternatively, submissions of large blocks of data could be effected using POST or PUT requests.

Remote meeting participants, such as remote participants 250 and 260 connect to collaboration server 240 over the Internet. Collaboration server 240 contains scripts providing instructions for reformatting the transferred images into a format accessible by the remote meeting participants. In the Internet case, the format would be that of a web page accessible by one of the ubiquitous web browser software applications such as NETSCAPE NAVIGATOR™ or MICROSOFT EXPLORER™. The web page would have embedded within it links to the received and reformatted compressed images. The embedded images would be updated on an ongoing basis as new images became available. Use of browser applets or ongoing web page refresh are two approaches contemplated.

A number of enhancements and additional functions are also contemplated.

For example, although this particular embodiment describes network 230 as being the Internet, no limitation of the interconnecting network is presumed. Insofar as image acquisition module 220 can transfer the images to collaboration server 240, and remote users can access collaboration server 240, any connection network is suitable. In the case of network 230 comprising the Internet, network 230 may be a network of networks, comprising local and wide area networks.

In an alternative contemplated embodiment, collaboration server 240 may support a number of simultaneous presentations. Each presentation would be associated with an image acquisition box and particular meeting code. The particular meeting code number would be used to associate a particular presenter and appropriate meeting participants. The particular meeting code could be used as a part of a password authentication process and also incorporated into the image stream.

In yet a further contemplated embodiment, in order to further minimize network bandwidth requirements, the image acquisition module 320 could implement a stream oriented protocol in which if a successive image differs from the previous image, only the differences are transmitted.

In a contemplated enhancement to the collaboration server 240 to remote participant interface, instead of participants performing periodical checking for a new image, a permanent TCP/IP connection with a daemon on collaboration server 240 could be established, allowing image updates as they become available.

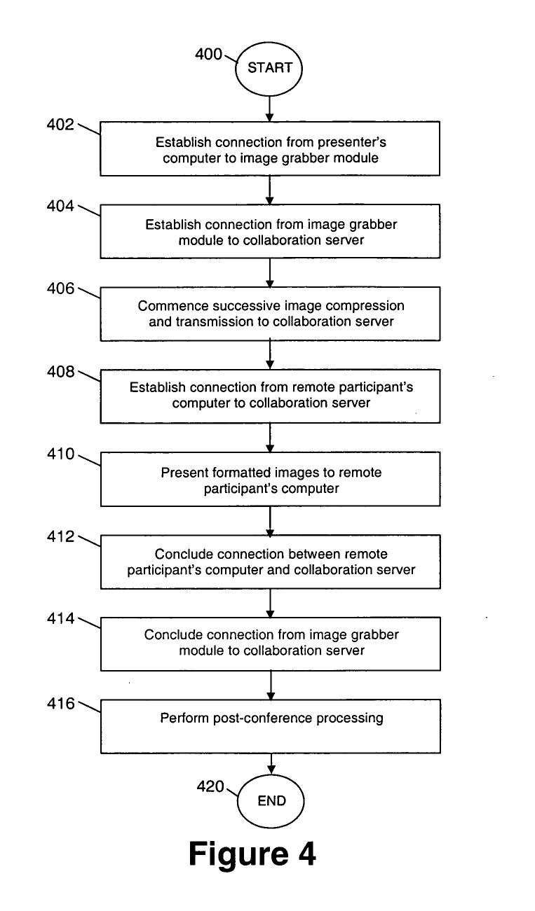

Referring to FIG. 4, there may be seen a flowchart depicting a process for providing a network based conference according to an embodiment of the invention.

The process commences at step 400. At step 402 a connection is established between the presenter's computer and the image acquisition module. The physical connection, as described previously, is via a video interface cable connected to a video output port on the presenter's computer. At step 404 a connection is established between the image acquisition module and a collaboration server. At step 406 transmission of successive compressed and formatted images is commenced between the image acquisition module and the collaboration server. At step 408 a remote participant establishes a connection to the collaboration server. At step 410 the collaboration server presents the formatted images to the remote participant's computer. The network conference concludes for the remote participant at step 412, where the connection between the remote participant's computer and collaboration server is concluded. At step 414 the network conference concludes as the connection between the image acquisition module and the collaboration server is concluded. At step 416 the collaboration server performs post conference processing. The process ends at step 420.

Each of the steps of the process admits a variety of sub-steps as previously described in the operation of the system. For example, step 402 may comprise establishment or confirmation of a particular meeting code. Alternatively this step could also include coordination of image transmission speed, image compression type, and other network signalling parameters. Likewise, step 408 may comprise authentication and authorization of the remote meeting participant. The post conference processing of step 416 may include billing, and archival functions. Although the steps have been portrayed as being executed in a particular sequence, this is not to be construed as the only or preferred sequence. For example, additional meeting participants may join in or depart the network conference at arbitrary points, necessitating repetition of steps 408 and 412 in parallel with step 410 i.e. while images are presented to other participants.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

1. An apparatus for providing near real time image conferencing from a video signal output from a computer, said apparatus comprising:
an input port for connection to the video output of a computer;
an image digitizing module, connected to the input port, for receiving a signal from said input port and constructing a digital image therefrom;
a controller module, connected to said image digitizing module, for generating a compressed representation of a digital image received from said image digitizing module; and
a network interface module; connected to said controller module, for transmission of said compressed representation to a network device.

2. An apparatus as in claim 1 wherein said controller module comprises a computer having a driver interface module for communication with said image digitizing module;
an image compression module for formatting an image obtained from said image digitizing module
a network process module for providing network protocol functions; and
a network interface driver module for communication with said network interface module.

3. An apparatus as in claim 2 wherein said network interface module comprises a modem for transmission to said network device over a telephonic network.

4. An apparatus as in claim 2 wherein said network interface module comprises a network interface card for transmission to said network device over a digital connection.

5. An apparatus as in claim 2 wherein said network interface module comprises a wireless interface card for transmission to said network device over a wireless connection.

6. An apparatus as in claim 2 wherein said network interface module comprises an infrared interface card for transmission to said network device over an infrared connection.

7. A system for providing near real time image conferencing from a video signal output from a computer across a network, said system comprising:
an image acquisition apparatus connected to said network, said image acquisition apparatus comprising an input port for connection to the video output of said computer;
an image digitizing module, connected to the input port, for receiving a signal from said input port and constructing a digital image therefrom;
a controller module, connected to said image digitizing module, for generating a compressed representation of a digital image received from said image digitizing module; and
a network interface module; connected to said controller module, for transmission of said compressed representation to said network; and
a collaboration server connected to said network for receiving said compressed representation wherein said collaboration server further formats said compressed representation for viewing.

8. A system as in claim 7 wherein said network comprises the Internet.

9. A system as in claim 7 wherein said further format comprises a format viewable by a web browser.

10. A system as in claim 7 wherein said collaboration server performs conferencing networking functions.

11. A system as in claim 10 wherein said conferencing networking function comprises an authentication function.

12. A system as in claim 10 wherein said conferencing networking function comprises an authorization function.

13. A system as in claim 10 wherein said conferencing networking function comprises a billing function.

14. A system as in claim 13 wherein said billing function comprises a per-use-billing function.

15. A system as in claim 10 wherein said conferencing networking function comprises post-conference functions.

16. A system as in claim 15 wherein said post-conference functions include archival functions.

17. A system as in claim 15 wherein said post-conference functions include playback functions.

18. A method for providing near real time image conferencing from a video signal output from a first computer across a network to a second computer, said method comprising the steps of:
establishing a video connection between said first computer and an image acquisition apparatus, said image acquisition apparatus comprising an input port for connection to the video signal output from said first computer;
an image digitizing module, connected to the input port, for receiving a signal from the input port and constructing a digital image therefrom;
a controller module, connected to said image digitizing module, for generating a compressed representation of a digital image received from said image digitizing module; and
a network interface module; connected to said controller module, for transmission of said compressed representation to said network;
connecting said network interface module to said network;
establishing a collaboration server connected to said network for acting as an image dissemination point;
establishing communication between said image acquisition apparatus and said collaboration server across said network;
transmitting said compressed representations from said image acquisition apparatus to said collaboration server across said network;
reformatting said compressed representations at said collaboration server;
establishing a connection between said second computer and said collaboration server across said network; and
providing said reformatted compressed representations from said collaboration server to said second computer.

19. A method as in claim 18 wherein said transmitting step further comprises varying the transmission of said compressed representation.

20. A method as in claim 19 wherein said varying the transmission of said compressed representation comprises adjusting said transmitting according to the opeSrating conditions of said network.

21. A method as in claim 19 wherein said varying the transmission of said compressed representation comprises adjusting said transmitting according to the complexity of said digital image.

22. A method as in claim 19 wherein said varying the transmission of said compressed representation further comprises adjusting said transmitting according to the speed of change of successive digital images.

23. A method as in claim 18 wherein said collaboration server performs conferencing networking functions.

24. A method as in claim 23 wherein said conferencing networking function comprises an authentication function.

25. A method as in claim 23 wherein said conferencing networking function comprises an authorization function.

26. A method as in claim 23 wherein said conferencing networking function comprises a billing function.

27. A method as in claim 26 wherein said billing function comprises a per-use billing function.
